(19) United States
(12) Patent Application Publication
(10) Pub. No.: US 2024/0055766 A1
(43) Pub. Date: Feb. 15, 2024

(54) ANTENNA DEVICE

(71) Applicant: Murata Manufacturing Co., Ltd., Nagaokakyo-shi (JP)

(72) Inventors: Takafumi NASU, Nagaokakyo-shi (JP); Toumu TANABE, Nagaokakyo-shi (JP)

(21) Appl. No.: 18/383,059

(22) Filed: Oct. 24, 2023

Related U.S. Application Data
(63) Continuation of application No. PCT/JP2022/010019, filed on Mar. 8, 2022.

(30) Foreign Application Priority Data
Apr. 28, 2021 (JP) 2021-076534

(51) Int. Cl. H01Q 9/04

(52) U.S. Cl. CPC H01Q 9/045; H01Q 9/0442

(57) ABSTRACT

An antenna device includes a feeder circuit, a patch antenna, an antenna, a first coil connected between the feeder circuit and the patch antenna, and a second coil connected to the antenna and magnetically coupled to the first coil. The patch antenna resonates in a first frequency range in a first direction and in a second frequency range in a second direction. The antenna resonates in a third frequency range. A first center frequency refers to the center frequency of the first frequency range, a second center frequency refers to the center frequency of the second frequency range, a third center frequency refers to the center frequency of the third frequency range, and an absolute value of a difference between the first center frequency and the third center frequency is less than an absolute value of a difference between the second center frequency and the third center frequency.

### CROSS REFERENCE TO RELATED APPLICATIONS

This application claims the benefit of priority to Japanese Patent Application No. 2021-076534 filed on Apr. 28, 2021 and is a Continuation Application of PCT Application No. PCT/JP2022/010019 filed on Mar. 8, 2022. The entire contents of each application are hereby incorporated herein by reference.

### BACKGROUND OF THE INVENTION

### 1. Field of the Invention

The present disclosure relates to an antenna device.

### 2. Description of the Related Art

An antenna device including two radiating elements directly or indirectly coupled to each other is used to achieve a wide range of frequency in which the antenna device can be used or accommodate two or more frequency bands. International Publication No. 2019/208297 discloses an antenna device in which one radiating element that is fed and the other radiating element that is not fed are coupled by using a transformer to achieve a wide range of frequency in which the antenna device can be used.

### SUMMARY OF THE INVENTION

in International Publication No. 2019/208297, one radiating element that is fed and the other radiating element that is not fed are both a line-shaped antenna, and these line-shaped antennas are formed in a region in which no ground electrode is disposed. However, as the multiple-input and multiple-output (MIMO) technology and the 5th generation mobile communication system (5G) advance, an antenna device needs to include a larger number of line-shaped antennas, and it has become increasingly difficult to accommodate line-shaped antennas in a region in which no ground electrode is disposed, resulting in a case where a line-shaped antenna is disposed above a ground electrode in some cases.

If a line-shaped antenna is disposed above a ground electrode, image current flows in a ground electrode portion located close to the line-shaped antenna, and the image current affects the radiation from the line-shaped antenna, greatly degrading the antenna characteristics.

Thus, preferred embodiments of the present invention provide antenna devices each having a wide range of usable frequency without regard to a region where no ground electrode is located.

An antenna device according to an aspect of a preferred embodiment of the present disclosure includes a feeder circuit to process signals in a first frequency range, a second frequency range, and a third frequency range, a first radiator with a patch structure capable of resonating in the first frequency range in a first direction and resonating in the second frequency range in a second direction, a second radiator to resonate in the third frequency range, a first coil connected between the feeder circuit and the first radiator, and a second coil connected to the second radiator and magnetically coupled to the first coil, wherein a first center frequency refers to a center frequency of the first frequency range, a second center frequency refers to a center frequency of the second frequency range, a third center frequency refers to a center frequency of the third frequency range, and an absolute value of a difference between the first center frequency and the third center frequency is less than an absolute value of a difference between the second center frequency and the third center frequency.

An antenna device according to another aspect of a preferred embodiment of the present disclosure includes a feeder circuit to process signals in a first frequency range, a second frequency range, and a third frequency range, a first radiator with a patch structure capable of resonating in the first frequency range in a first direction and resonating in the second frequency range in a second direction, a second radiator to resonate in the third frequency range, a first coil connected between the feeder circuit and the first radiator, and a second coil connected to the second radiator and magnetically coupled to the first coil, wherein the first radiator includes a first end portion and a second end portion located on the other side from the first end portion, an electric field generated in the first end portion and an electric field generated in the second end portion have opposite polarities when the first radiator resonates in the first frequency range, the second radiator is closer to the first end portion than to the second end portion, and an electric field generated in the second radiator when the second radiator resonates in the third frequency range has the same polarity as an electric field generated in the first end portion of the first radiator.

According to preferred embodiments of the present disclosure, a first coil connected to a first radiator with a patch structure is magnetically coupled to a second coil connected to a second radiator, and thus, a wide range of usable frequency may be obtained without regard to a region where no ground electrode is disposed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a plan view of an antenna device according to a first preferred embodiment of the present invention.

FIG. 2 is a circuit diagram of the antenna device according to the first preferred embodiment of the present invention.

FIG. 3 depicts frequency characteristics of a reflection coefficient of the antenna device according to the first preferred embodiment of the present invention.

FIG. 4 depicts radiation efficiency of the antenna device according to the first preferred embodiment of the present invention.

FIGS. 5A to 5C depict distributions of an electric field in the antenna device according to the first preferred embodiment of the present invention.

FIG. 6 is a schematic diagram depicting a configuration of the antenna device according to the first preferred embodiment of the present invention.

FIGS. 7A and 7B depict a case where a magnetic field generated in a first coil is oriented differently from a magnetic field generated in a second coil.

FIG. 8 is a plan view of an antenna device according to a second preferred embodiment of the present invention.

FIG. 9 is a plan view of another antenna device according to the second preferred embodiment of the present invention.

FIG. 10 is a plan view of an antenna device according to a third preferred embodiment of the present invention.

FIG. 11 depicts radiation efficiency of the antenna device according to the third preferred embodiment of the present invention.

FIG. 12 is a plan view of another antenna device according to the third preferred embodiment of the present invention.

FIG. 13 depicts radiation efficiency of the other antenna device according to the third preferred embodiment of the present invention.

FIG. 14 is a plan view of still another antenna device according to the third preferred embodiment of the present invention.

FIG. 15 is a plan view of an antenna device according to a fourth preferred embodiment of the present invention.

FIG. 16 depicts radiation efficiency of the antenna device according to the fourth preferred embodiment of the present invention.

### DETAILED DESCRIPTION OF THE PREFERRED EMBODIMENTS

Hereinafter, antenna devices according to preferred embodiments of the present disclosure will be described in detail with reference to the drawings. The same symbols denote the same or equivalent elements in the drawings.

### First Preferred Embodiment

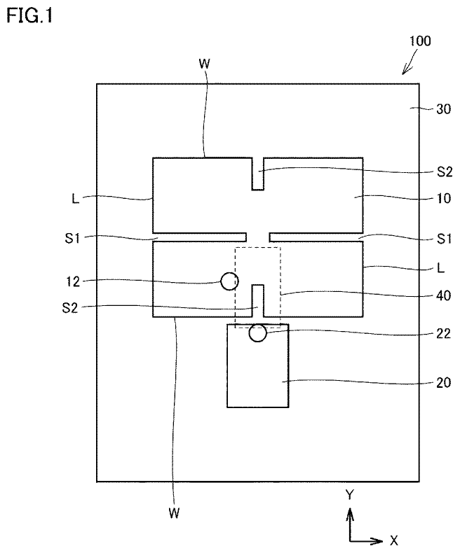

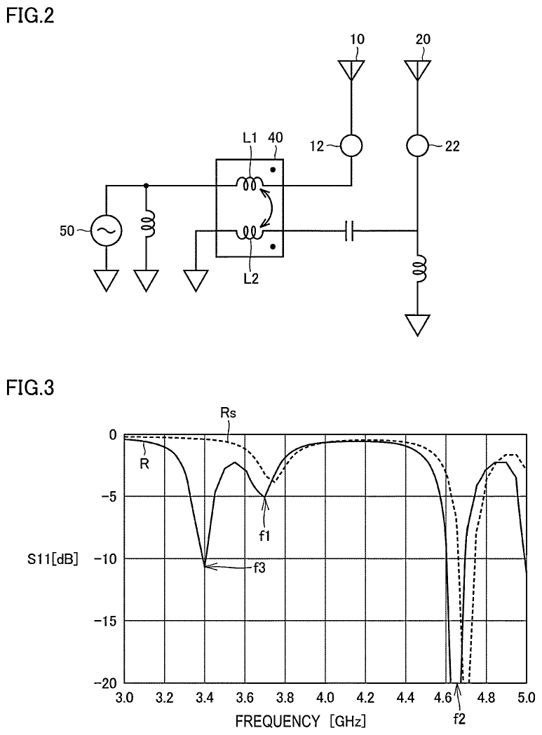

First, an antenna device according to a first preferred embodiment will be described with reference to the drawings. FIG. 1 is a plan view of an antenna device 100 according to a first preferred embodiment. FIG. 2 is a circuit diagram of the antenna device 100 according to the first preferred embodiment. The side-to-side direction in FIG. 1 is referred to as the X direction, and the up-and-down direction in FIG. 1 is referred to as the Y direction.

The antenna device 100 is configured to transmit and receive electromagnetic waves in a first frequency range, a second frequency range, and a third frequency range. Obviously, the antenna device 100 may be used in only one of the transmission and reception modes. A first resonant frequency refers to the center frequency of the first frequency range, a second resonant frequency refers to the center frequency of the second frequency range, and a third resonant frequency refers to the center frequency of the third frequency range.

As depicted in FIG. 1, the antenna device 100 includes a patch antenna 10, an antenna 20, a substrate 30, and an antenna coupling element 40. In the following description, a surface of the substrate 30 on which the patch antenna 10 is disposed is referred to as the front surface of the antenna device 100, and a surface of the substrate 30 on which the patch antenna 10 is not disposed is referred to as a back surface of the antenna device 100.

Even if an antenna is disposed above a ground electrode, the antenna device 100 can achieve good antenna characteristics since the patch antenna 10 rather than a line-shaped antenna is adopted to reduce the effect of the ground electrode. In other words, since the patch antenna 10 is adopted in the antenna device 100, an antenna can be disposed without regard to a region where no ground electrode is disposed. Further, since the patch antenna 10 is magnetically coupled to the antenna 20 by using the antenna coupling element 40, the antenna device 100 achieves a wider frequency range than an antenna device having only one patch antenna.

The patch antenna 10 is a rectangular or substantially rectangular conductor pattern on the front surface of the substrate 30. The patch antenna 10 is a radiator with a patch structure (first radiator) capable of resonating in the first frequency range in the X direction (first direction) and resonating in the second frequency range in the Y direction (second direction). A first side configured to resonate in the first frequency range is referred to as a side L, and a second side configured to resonate in the second frequency range is referred to as a side W.

The patch antenna 10 has a rectangular or substantially rectangular shape elongated in the X direction. A slit S1 (first slit) on each short side L of the patch antenna 10 is longer than a slit S2 (second slit) on each long side W of the patch antenna 10. Namely, the perimeter of each short side L including the slit S1 is larger than the perimeter of each long side W including the slit S2.

The antenna 20 is a line-shaped conductor pattern located on the front surface of the substrate 30. The antenna 20 is a radiating element configured to resonate in the third frequency range (second radiator).

The substrate 30 is formed of dielectric material having a predetermined relative permittivity, such as a resin. A plate-shaped conductive member made of a conductor such as copper, which is not depicted, is disposed on the back surface of the substrate 30 to define a ground electrode. The ground electrode is formed, for example, on the back surface of a printed circuit board by a method such as electroplating.

The patch antenna 10 and the antenna 20 are connected to the antenna coupling element 40. A point at which the antenna coupling element 40 is connected to the patch antenna 10 is referred to as a connection point 12 (first connection point), and a point at which the antenna coupling element 40 is connected to the antenna 20 is referred to as a connection point 22 (second connection point). The connection point 12 is disposed so as to be superimposed on the patch antenna 10, and the connection point 22 is disposed at a position in the antenna 20 closer to either of the long sides W of the patch antenna 10. The antenna coupling element 40 is disposed in or on a printed circuit board on the back surface of the substrate 30, and no ground electrode is provided in a region of the printed circuit board in or on which the antenna coupling element 40 is disposed.

The circuit diagram of the antenna device 100 depicted in FIG. 2 indicates that the patch antenna 10 is connected to a feeder circuit 50 and defines a feed element and that the antenna 20 is not connected to the feeder circuit 50 and defines a non-feed antenna element. The patch antenna 10 is magnetically coupled to the antenna 20 by using the antenna coupling element 40. The antenna coupling element 40 includes a first coil L1 and a second coil L2 that are magnetically coupled to each other. The antenna coupling element 40 may perform not only magnetic coupling but also electromagnetic coupling including electric coupling. Examples of the antenna coupling element 40 include a chip component including a ceramic multilayer substrate of a cuboid shape. The magnetic field generated in the first coil L1 by the current flowing from the first coil L1 toward the connection point 12 is oriented in the same direction as the magnetic field generated in the second coil L2 by the current flowing from the second coil L2 toward the connection point 22. The dots in FIG. 2 indicate this relationship.

The feeder circuit 50 is configured to receive and output communication signals in a communication frequency range, and such communication signals include signals in the first frequency range, the second frequency range, and the third frequency range.

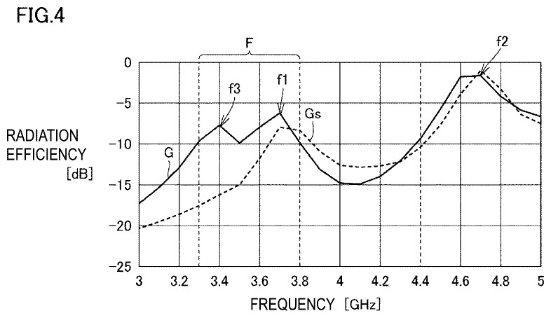

FIG. 3 depicts frequency characteristics of a reflection coefficient of the antenna device 100 according to the first preferred embodiment. In FIG. 3, the horizontal axis represents frequency, and the vertical axis represents a reflection coefficient. FIG. 4 depicts radiation efficiency of the antenna device 100 according to the first preferred embodiment. In FIG. 4, the horizontal axis represents frequency, and the vertical axis represents radiation efficiency (=radiated electric power/electric power that is input into an antenna). The reflection coefficient R represents the reflection coefficient of the antenna device 100. The radiation efficiency G represents the radiation efficiency of the antenna device 100. The reflection coefficient Rs represents the reflection coefficient of an antenna device according to a comparative example. The radiation efficiency Gs represents the radiation efficiency of the antenna device according to the comparative example. The antenna device according to the comparative example includes only the patch antenna 10.

In FIGS. 3 and 4, a first resonant frequency f1 represents a lower resonant frequency of the patch antenna 10 including the first coil L1, and a second resonant frequency f2 represents a higher resonant frequency of the patch antenna 10 including the first coil L1. A third resonant frequency f3 represents a resonant frequency of the antenna 20 including the second coil L2. As can be seen in FIGS. 3 and 4, the third resonant frequency f3 of the antenna 20 located in the vicinity of the first resonant frequency f1 of the patch antenna 10 provides a wide range of usable frequency, that is, a frequency range F including the first resonant frequency f1 and the third resonant frequency f3. In other words, as depicted in FIG. 4, the graph of the radiation efficiency G indicates that the radiation efficiency is higher in the vicinity of the third resonant frequency f3 than the radiation efficiency Gs. In the present preferred embodiment, the first frequency range and the third frequency range are identical to a frequency range of about 3.3 GHz to about 3.8 GHz (n78 band), and the first center frequency and the third center frequency equal to about 3.55 GHz, for example. The second frequency range is identical to a frequency range of about 4.4 GHz to about 5.0 GHz (n79 band), and the second center frequency equals about 4.7 GHz, for example.

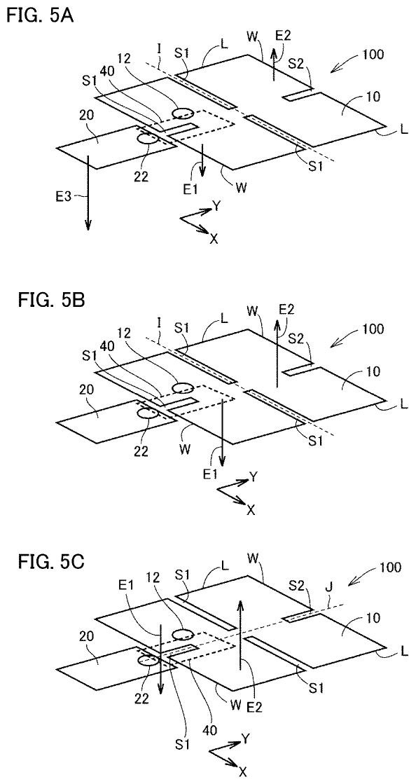

Next, description will be given with regard to the relationship between the location of the antenna 20 relative to the patch antenna 10 and a distribution of an electric field in the antenna device 100. FIGS. 5A to 5C depict distributions of an electric field in the antenna device 100 according to the first preferred embodiment. FIG. 5A depicts a distribution of an electric field in the antenna device 100 at the third resonant frequency f3. In the antenna device 100, at the third resonant frequency f3, since dominant current flows from the connection point 22 of the antenna 20 toward the open end of the antenna 20, which is located on the other side of the antenna 20 from the connection point 22, an electric field E3 oriented toward the back surface of the antenna device 100 is generated in the antenna 20. The current flowing in the antenna 20 has a current amplitude corresponding to about λ/4 between the connection point 22 and the open end. The symbol λ refers to the wavelength of the electromagnetic wave having a resonant frequency.

Due to current flowing in the Y direction in the patch antenna 10, an electric field E1 oriented toward the back surface of the antenna device 100 is generated on the connection point 12 side of the center axis I, which runs along the line connecting the slits S1, and an electric field E2 oriented toward the front surface of the antenna device 100 is generated on the other side from the connection point 12.

As depicted in FIG. 5A, the antenna 20 is disposed close to one of the long sides W of the patch antenna 10 in the antenna device 100, and the open end of the antenna 20 is disposed away from the long side W. This arrangement reduces the effect of the electric field E3 in the antenna 20 on the electric field E2 in the patch antenna 10.

FIG. 5B depicts a distribution of an electric field in the antenna device 100 at the first resonant frequency f1. In the antenna device 100, at the first resonant frequency f1, since dominant current flows in the Y direction in the patch antenna 10, the electric field E1 oriented toward the back surface of the antenna device 100 is generated on the connection point 12 side of the center axis I, and the electric field E2 oriented toward the front surface of the antenna device 100 is generated on the other side from the connection point 12. The current flowing in the patch antenna 10 has a current amplitude corresponding to λ/2 between one of the long sides W and the other of the long sides W.

FIG. 5C depicts a distribution of an electric field in the antenna device 100 at the second resonant frequency f2. In the antenna device 100, at the second resonant frequency f2, since dominant current flows in the X direction in the patch antenna 10, the electric field E1 oriented toward the back surface of the antenna device 100 is generated on the connection point 12 side of the center axis J, which runs along the line connecting the slits S2, and the electric field E2 oriented toward the front surface of the antenna device 100 is generated on the other side from the connection point 12. The current flowing in the patch antenna 10 has a current amplitude corresponding to λ/2 between one of the short sides L and the other of the short sides L.

The connection point 12, at which the patch antenna 10 is connected to the first coil L1, is preferably disposed at a position displaced in one direction from the center axis J of the patch antenna 10. This arrangement enables impedance matching between the patch antenna 10 and the first coil L1. Obviously, the connection point 12 may be disposed on the center axis J if another method achieves the impedance matching between the patch antenna 10 and the first coil L1.

The absolute value of the difference between the first resonant frequency f1 and the third resonant frequency f3 is less than the absolute value of the difference between the second resonant frequency f2 and the third resonant frequency f3 for the antenna device 100. The absolute value of the difference between the first center frequency, 3.55 GHz, and the third center frequency, 3.55 GHz, is zero and less than the absolute value, 1.15 GHz, of the difference between the second center frequency, 4.7 GHz, and the third center frequency, 3.55 GHz, for example. In other words, the shape of the antenna 20 is selected so that the third center frequency of the antenna 20 is close to the first center frequency of the patch antenna 10. Further, in the antenna device 100, the antenna 20 is disposed closer to one of the long sides W of the patch antenna 10, which are configured to resonate at the second center frequency, than to the short sides L of the patch antenna 10, which are configured to resonate at the first center frequency.

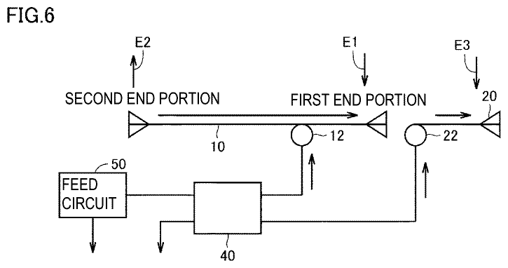

The antenna 20 is disposed close to one of the long sides W of the patch antenna 10 in this way, and thus an electric field generated in the antenna 20 at the third resonant frequency f3 has the same polarity as an electric field generated in the portion of the patch antenna 10 close to the antenna 20. FIG. 6 is a schematic diagram depicting a configuration of the antenna device 100 according to the first preferred embodiment. FIG. 6 schematically indicates that the electric field E1 generated at a first end portion of the patch antenna 10 has the polarity opposite to that of the electric field E2 generated at a second end portion of the patch antenna 10 in the antenna device 100. As depicted in FIG. 6, the antenna 20 is disposed close to the first end portion of the patch antenna 10, where the generated electric field in the antenna 20 has the same polarity as the electric field generated in the patch antenna 10 when the electric field E3 is generated in the antenna 20 at the third resonant frequency f3. In this way, since the antenna 20, which is magnetically coupled to the patch antenna 10, is appropriately disposed, the antenna device 100 provides a wide range of usable frequency, that is, a frequency range F including the first resonant frequency f1 and the third resonant frequency f3.

Next, description will be given with regard to a situation in which the wide range of frequency that is provided depends on whether magnetic fields generated in the first coil L1 and the second coil L2 in the antenna coupling element 40 are oriented in the same direction or in different directions. FIG. 2 depicts a situation in which the antenna coupling element 40 is configured to generate in the first coil L1 a magnetic field oriented in the same direction as a magnetic field generated in the second coil L2. In the case depicted in FIG. 2, the third resonant frequency f3 of the antenna 20 is located in a frequency range lower than the first resonant frequency f1 of the patch antenna 10. Namely, since the first coil L1 and the second coil L2 in the antenna coupling element 40 define a transformer having subtractive polarity, the third resonant frequency f3 is located in a frequency range lower than the first resonant frequency f1.

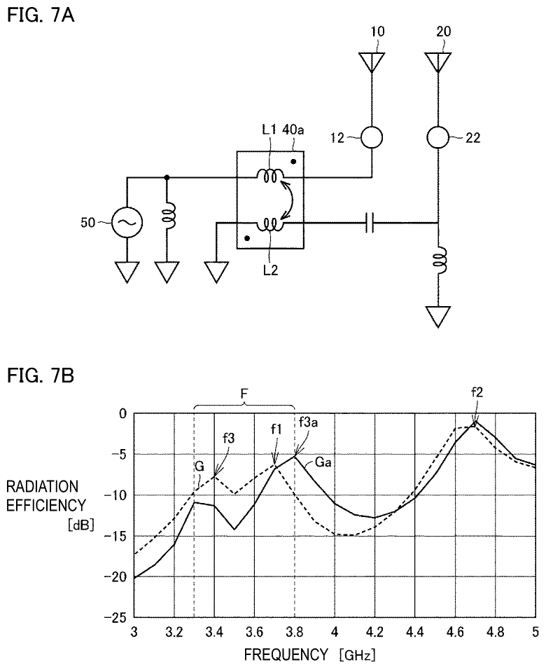

Description will be given herein with regard to a situation in which the magnetic field generated in the first coil L1 is oriented differently from the magnetic field generated in the second coil L2 in the antenna coupling element 40. FIGS. 7A and 7B depict a case where the magnetic field generated in the first coil L1 is oriented differently from the magnetic field generated in the second coil L2. FIG. 7A is a circuit diagram of the antenna device 100 including an antenna coupling element 40a configured to generate in the first coil L1 a magnetic field oriented differently from a magnetic field generated in the second coil L2. The elements except the antenna coupling element 40a are the same as those in the circuit diagram of the antenna device 100 depicted in FIG. 2, and the same elements are denoted by the same symbols without detailed descriptions thereof.

As depicted in FIG. 7A, if the antenna coupling element 40a is configured to generate in the first coil L1 a magnetic field oriented differently from a magnetic field generated in the second coil L2, the third resonant frequency f3 of the antenna 20 is located in a frequency range higher than the first resonant frequency f1 of the patch antenna 10. Namely, since the first coil L1 and the second coil L2 in the antenna coupling element 40a define a transformer having additive polarity and the phase of the electric field in subtractive polarity is reversed, the third resonant frequency f3 is located in a frequency range higher than the first resonant frequency f1.

FIG. 7B depicts radiation efficiency of the antenna device 100. In FIG. 7B, the horizontal axis represents frequency, and the vertical axis represents radiation efficiency. Radiation efficiency G refers to radiation efficiency of the antenna device 100 including the antenna coupling element 40a, which has additive polarity. Radiation efficiency Ga refers to radiation efficiency of the antenna device 100 including the antenna coupling element 40a, which has additive polarity. The antenna device 100, which includes the antenna coupling element 40a having additive polarity, has the third resonant frequency f3a located in a frequency range higher than the first resonant frequency f1 as can be seen in the graph of the radiation efficiency Ga in FIG. 7B.

In this way, changing the polarity of the antenna coupling element in the antenna device 100 enables control of a range of usable frequency.

As described above, the antenna device 100 according to the first preferred embodiment includes the feeder circuit 50 configured to process signals in the first frequency range, the second frequency range, and the third frequency range, the patch antenna 10 capable of resonating in the first frequency range in the first direction and resonating in the second frequency range in the second direction, the antenna 20 configured to resonate in the third frequency range, the first coil L1 connected between the feeder circuit 50 and the patch antenna 10, and the second coil L2 that is connected to the antenna 20 and that is magnetically coupled to the first coil L1. The first resonant frequency f1 refers to the center frequency of the first frequency range, the second resonant frequency f2 refers to the center frequency of the second frequency range, and the third resonant frequency f3 refers to the center frequency of the third frequency range. The absolute value of the difference between the first resonant frequency f1 and the third resonant frequency f3 is less than the absolute value of the difference between the second resonant frequency f2 and the third resonant frequency f3. The absolute value of the difference between the first center frequency, 3.55 GHz, and the third center frequency, 3.55 GHz, is zero and less than the absolute value, 1.15 GHz, of the difference between the second center frequency, 4.7 GHz, and the third center frequency, 3.55 GHz, for example. The antenna 20 is disposed closer to one of the long sides W, which are configured to resonate in the second frequency range, than to the short sides L, which are configured to resonate in the first frequency range, of the patch antenna 10.

The first coil L1 connected to the patch antenna 10 is magnetically coupled to the second coil L2 connected to the antenna 20 in the antenna device 100 according to the first preferred embodiment, and thus a wide range of usable frequency may be obtained without regard to a region where no ground electrode is disposed.

Further, in a resonance state in the first frequency range, the electric field generated in the first end portion of the patch antenna 10 preferably has the polarity opposite to the polarity of the electric field generated in the second end portion located on the other side from the first end portion, the antenna 20 is preferably disposed closer to the first end portion than to the second end portion, and in a resonance state in the third frequency range, the electric field generated in the antenna 20 preferably has the same polarity as the electric field generated in the first end portion of the patch antenna 10. These arrangements achieve a wide range of usable frequency.

The patch antenna 10 preferably has the long sides W longer than the short sides L, and the slit S1 located on each of the short sides L is preferably longer than the slit S2 located on each of the long sides W. This arrangement enables the patch antenna 10 to resonate in the first frequency range on the short sides L and to resonate in the second frequency range on the long sides W.

The connection point 12, at which the patch antenna 10 is connected to the first coil L1, is preferably disposed at a position displaced in one direction from the center axis J of the patch antenna 10. This arrangement enables the impedance matching between the patch antenna 10 and the first coil L1.

The connection point 22, at which the antenna 20 is connected to the second coil L2, is preferably disposed at a position in the antenna 20 closer to the patch antenna 10. This arrangement allows the line connecting the antenna 20 and the second coil L2 to be short.

Further, the open end of the antenna 20 located farthest from the connection point 22 is preferably disposed farther from the patch antenna 10 than the connection point 22 is. This arrangement may reduce the effect of the electric field E3 in the antenna 20 on the electric field E2 in the patch antenna 10.

The electric field generated in the first end portion of the patch antenna 10 has the polarity opposite to the polarity of the electric field generated in the second end portion located on the other side from the first end portion. The antenna 20 is preferably disposed close to the first end portion of the patch antenna 10 (for example, refer to FIG. 5A), where the generated electric field has the same polarity as the electric field generated in the antenna 20 in the third frequency range. In this way, the first coil L1 connected to the patch antenna 10 is magnetically coupled to the second coil L2 connected to the antenna 20, and thus a wide range of usable frequency may be obtained without regard to a region where no ground electrode is disposed.

### Second Preferred Embodiment

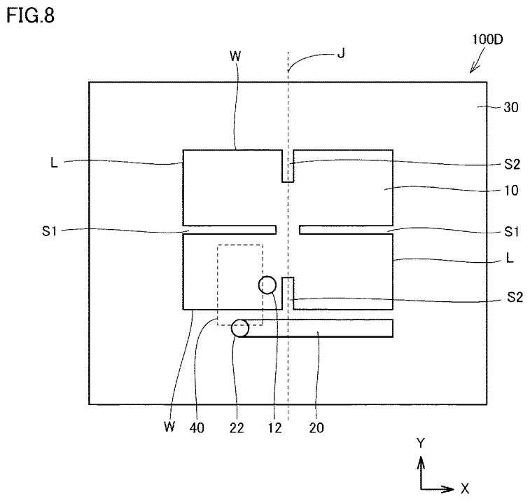

In the first preferred embodiment, the description has been given with regard to the configuration in which the antenna 20 is disposed closer to one of the long sides W of the patch antenna 10 than to the short sides L of the patch antenna 10 and the open end of the antenna 20 is disposed away from the long side W. However, this configuration of the antenna device is not meant to be limiting, and the open end of the antenna 20 may be disposed close to the long side W, as the connection point 22 is. Specifically, if the area on the long side W of the patch antenna 10 needs to be reduced, a configuration in which the open end of the antenna 20 is disposed close to the long side W is effective. FIG. 8 is a plan view of an antenna device 100D according to a second preferred embodiment.

The antenna device 100D includes the antenna 20 disposed closer to one of the long sides W of the patch antenna 10 than to the short sides L of the patch antenna 10, and the antenna 20 is disposed along the long side W of the patch antenna 10. Thus, the open end of the antenna 20, which is located on the other side from the connection point 22, is disposed close to the long side W, as the connection point 22 is. The antenna device 100D, which is depicted in FIG. 8, includes the same elements as the antenna device 100 depicted in FIG. 1 except the arrangement of the antenna 20, and the same elements are denoted by the same symbols without detailed description thereof.

As depicted in FIG. 8, the antenna 20 includes the open end disposed on the right-hand side in FIG. 8. In the antenna device 100D, since the antenna 20 configured to generate the electric field E3 as depicted in FIG. 5A is disposed close to the right-hand side portion of the patch antenna 10 in FIG. 8, the electric field E3 generated in the antenna 20 is located close to a portion of the patch antenna 10 where the electric field E2 is generated (the right-hand side of the center axis J in FIG. 8) as depicted in FIG. 5C.

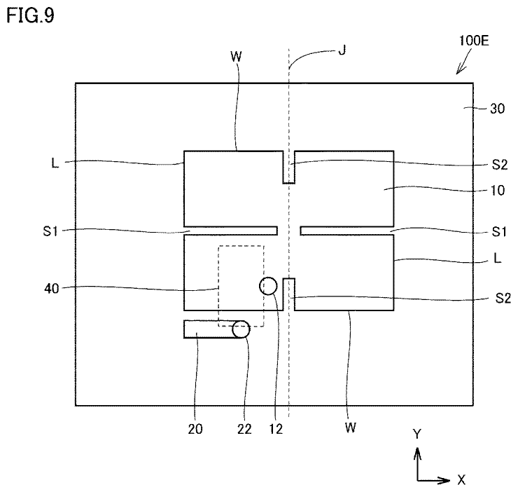

The antenna 20 is preferably disposed away from the portion of the patch antenna 10 where the electric field E2 is generated as depicted in FIG. 5C. FIG. 9 is a plan view of another antenna device 100E according to the second preferred embodiment.

The antenna device 100E includes the antenna 20 disposed closer to one of the long sides W of the patch antenna 10 than to the short sides L of the patch antenna 10, and the antenna 20 is disposed along the long side W of the patch antenna 10. As depicted in FIG. 9, the antenna 20 includes the open end disposed on the left-hand side in FIG. 9. Thus, the electric field E3 generated in the antenna 20 is located away from the portion of the patch antenna 10 where the electric field E2 is generated as depicted in FIG. 5C. Specifically, the open end of the antenna 20 is disposed close to a portion of the patch antenna 10 where the electric field E1 is generated as depicted in FIG. 5C, the electric field E1 having the same polarity as the electric field E3 generated in the antenna 20. The antenna device 100E, which is depicted in FIG. 9, includes the same elements as the antenna device 100 depicted in FIG. 1 except the arrangement of the antenna 20, and the same elements are denoted by the same symbols without detailed description thereof.

As described above, in the antenna devices 100D and 100E according to the second preferred embodiment, the open end of the antenna 20 located farthest from the connection point 22 is disposed close to the patch antenna 10. In this way, an unused area that is created when the open end of the antenna 20 is disposed away from the long side W may be reduced in the antenna devices 100D and 100E according to the second preferred embodiment.

In the antenna device 100E according to the second preferred embodiment, the open end of the antenna 20 is preferably disposed close to a portion of the patch antenna 10 where the generated electric field has the same polarity as the electric field generated at the open end of the antenna 20. This arrangement may reduce the effect of the electric field generated in the portion of the patch antenna 10, the electric field having the same polarity as the electric field generated in the antenna 20.

### Third Preferred Embodiment

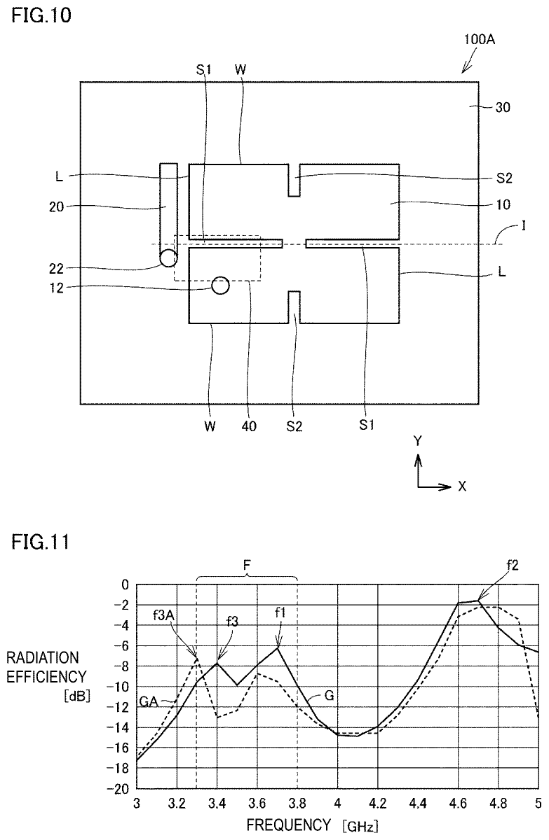

In the first preferred embodiment, the description has been given with regard to the antenna device 100 including the antenna 20 disposed closer to one of the long sides W of the patch antenna 10 than to the short sides L of the patch antenna 10. This configuration of the antenna device is not meant to be limiting, and the antenna 20 may be disposed closer to one of the short sides L of the patch antenna 10 than to the long sides W of the patch antenna 10. In particular, if the length of the patch antenna 10 needs to be reduced in the Y-axis direction, placing the antenna 20 close to one of the short sides L of the patch antenna 10 is effective. FIG. 10 is a plan view of an antenna device 100A according to a third preferred embodiment. FIG. 11 depicts radiation efficiency of the antenna device 100A according to the third preferred embodiment.

In the antenna device 100A, the antenna 20 is disposed closer to one of the short sides L of the patch antenna 10 than to the long sides W of the patch antenna 10. The antenna device 100A, which is depicted in FIG. 10, includes the same elements as the antenna device 100 depicted in FIG. 1 except the arrangement of the antenna 20, and the same elements are denoted by the same symbols without detailed description thereof.

The antenna 20 is a line-shaped conductor pattern formed on the front surface of the substrate 30. The connection point 22, at which the antenna coupling element 40 is connected to the antenna 20, is disposed close to the short side L of the patch antenna 10. The connection point 12, at which the antenna coupling element 40 is connected to the patch antenna 10, is disposed below the center axis I in FIG. 10, and the connection point 22 is also disposed below the center axis I in FIG. 10.

The antenna 20 is disposed along the short side L of the patch antenna 10. Thus, the open end of the antenna 20, which is located on the other side from the connection point 22, is disposed close to the short side L, as the connection point 22 is.

In the antenna device 100A, since the antenna 20 configured to generate the electric field E3 as depicted in FIG. 5A is disposed along the short side L of the patch antenna 10, the electric field E3 generated in the antenna 20 is located close to a portion of the patch antenna 10 where the electric field E2 is generated. Due to this arrangement, the effect of the electric field E3 in the antenna 20 on the electric field E2 in the patch antenna 10 is larger than for the antenna device 100.

Since the effect of the electric field E3 in the antenna 20 on the electric field E2 in the patch antenna 10 is larger, as can be seen in the graph of radiation efficiency GA of the antenna device 100A depicted in FIG. 11, the third resonant frequency f3A shifts to a frequency lower than the third resonant frequency f3 of the antenna device 100.

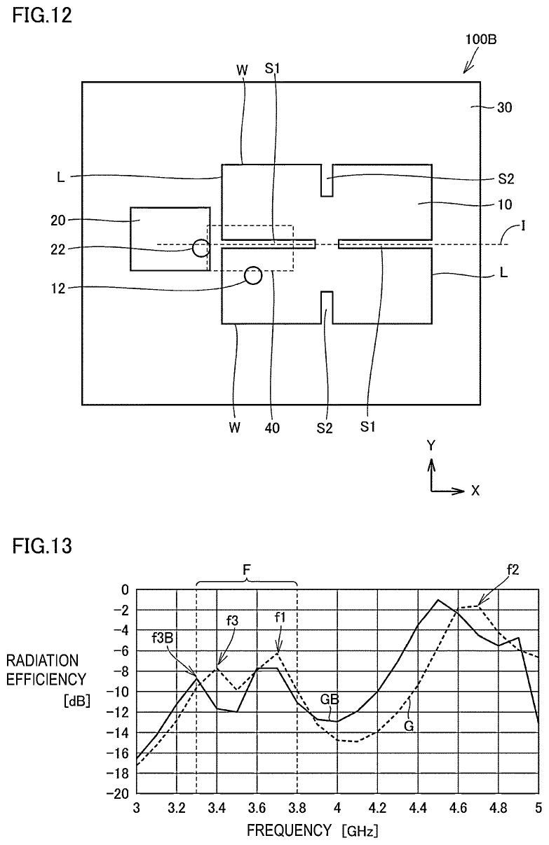

Next, description will be given with regard to the configuration in which the antenna 20 is disposed close to one of the short sides L of the patch antenna 10 but the open end of the antenna 20 is disposed away from the long sides W. FIG. 12 is a plan view of another antenna device 100B according to the third preferred embodiment. FIG. 13 depicts radiation efficiency of the other antenna device 100B according to the third preferred embodiment.

In the antenna device 100B, the antenna 20 is disposed closer to one of the short sides L of the patch antenna 10 than to the long sides W of the patch antenna 10. The antenna 20 is disposed in a direction perpendicular to the short side L of the patch antenna 10. Thus, the open end of the antenna 20, which is located on the other side from the connection point 22, is disposed farther from the short side L than the connection point 22 is. The antenna device 100B, which is depicted in FIG. 12, includes the same elements as the antenna device 100 depicted in FIG. 1 except the arrangement of the antenna 20, and the same elements are denoted by the same symbols without detailed description thereof.

In the antenna device 100B, since the antenna 20 configured to generate the electric field E3 as depicted in FIG. 5A is disposed in a direction perpendicular to the short side L of the patch antenna 10, the electric field E3 generated at the open end of the antenna 20 is located away from the portion of the patch antenna 10 where the electric field E2 is generated, but the electric field E3 generated on the connection point 22 side of the antenna 20 remains close to the portion of the patch antenna 10 where the electric field E2 is generated. This arrangement in the antenna device 100B reduces the effect of the electric field E3 in the antenna 20 on the electric field E2 in the patch antenna 10 compared with the antenna device 100A, but the effect is larger than that for the antenna device 100.

Since the effect of the electric field E3 in the antenna 20 on the electric field E2 in the patch antenna 10 is larger, as can be seen in the graph of radiation efficiency GB of the antenna device 100B depicted in FIG. 13, the third resonant frequency f3B shifts to a frequency lower than the third resonant frequency f3 of the antenna device 100.

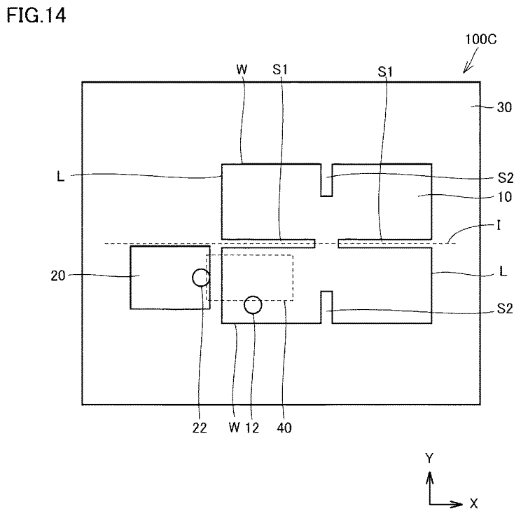

To further reduce the effect of the electric field E3 generated on the connection point 22 side of the antenna 20 on the electric field E2 in the patch antenna 10, the antenna 20 is preferably disposed below the center axis I of the patch antenna 10 in FIG. 12. FIG. 14 is a plan view of still another antenna device 100C according to the third preferred embodiment.

In the antenna device 100C, the antenna 20 is disposed below the center axis I of the patch antenna 10 in FIG. 14 and closer to one of the short sides L of the patch antenna 10 than to the long sides W of the patch antenna 10. The antenna 20 is disposed in a direction perpendicular to the short side L of the patch antenna 10. Thus, the connection point 22 of the antenna 20 is disposed close to the short side L of the patch antenna 10 away from the portion of the patch antenna 10 where the electric field E2 is generated. The antenna device 100C, which is depicted in FIG. 14, includes the same elements as the antenna device 100 depicted in FIG. 1 except the arrangement of the antenna 20, and the same elements are denoted by the same symbols without detailed description thereof.

As described above, the antenna devices 100A to 100C according to the third preferred embodiment each include the antenna 20 disposed close to one of the short sides L of the patch antenna 10. In this way, an unused area that is created when the antenna 20 is disposed close to one of the long sides W of the patch antenna 10 may be reduced in the antenna devices 100A to 100C according to the third preferred embodiment.

### Fourth Preferred Embodiment

In the first preferred embodiment, the description has been given with regard to the antenna device 100 including the patch antenna 10 with the slits S1 and S2. However, the configuration of the antenna device is not limited to this particular design, and the antenna device may include a patch antenna with no slit. FIG. 15 is a plan view of an antenna device 100F according to a fourth preferred embodiment. The antenna device 100F includes a patch antenna 10F with no slit. The antenna device 100F, which is depicted in FIG. 15, includes the same elements as the antenna device 100 depicted in FIG. 1 except the patch antenna 10F, and the same elements are denoted by the same symbols without detailed description thereof.

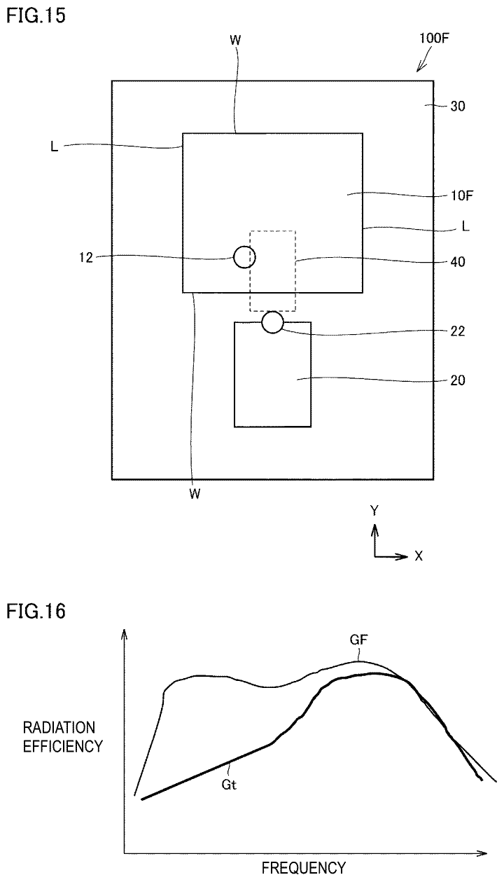

FIG. 16 depicts radiation efficiency of the antenna device 100F according to the fourth preferred embodiment. In FIG. 16, the horizontal axis represents frequency, and the vertical axis represents radiation efficiency. The radiation efficiency GF represents the radiation efficiency of the antenna device 100F. The radiation efficiency Gt represents the radiation efficiency of an antenna device according to a comparative example. The antenna device according to the comparative example includes only the patch antenna 10F with no slit. As depicted in FIG. 16, the graph of the radiation efficiency GF indicates that the radiation efficiency is higher in a low frequency region than the radiation efficiency Gt. The first coil L1 connected to the patch antenna 10F with no slit is magnetically coupled to the second coil L2 connected to the antenna 20 in the antenna device 100F, and thus a wide range of usable frequency may also be obtained without regard to a region where no ground electrode is disposed.

### Modifications

In the present disclosure, the description has been given with regard to the antenna devices each including the antenna 20 disposed in a direction perpendicular to the patch antenna 10 or in a direction parallel to the patch antenna 10. However, these arrangements are not meant to be limiting, and the antenna devices according to preferred embodiments of the present disclosure may each include the antenna 20 disposed at a predetermined angle with respect to the patch antenna 10.

In the present disclosure, the description has been given with regard to the antenna devices each including the slit S1 on each short side L and the slit S2 on each long side W. However, these arrangements are not meant to be limiting, and the antenna devices according to the present disclosure may each include either only the slit S1 on each short side L or only the slit S2 on each long side W.

The elements, features, and characteristics of the above preferred embodiments have been described by way of example only. The combinations of the elements are not limited to the combination in each preferred embodiment, and an element, feature, or characteristic described in a preferred embodiment may be used in another preferred embodiment.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device comprising:
a feeder circuit to process signals in a first frequency range, a second frequency range, and a third frequency range;
a first radiator with a patch structure capable of resonating in the first frequency range in a first direction and resonating in the second frequency range in a second direction;
a second radiator to resonate in the third frequency range;
a first coil connected between the feeder circuit and the first radiator; and
a second coil connected to the second radiator and magnetically coupled to the first coil; wherein
a first center frequency refers to a center frequency of the first frequency range;
a second center frequency refers to a center frequency of the second frequency range;
a third center frequency refers to a center frequency of the third frequency range; and
an absolute value of a difference between the first center frequency and the third center frequency is less than an absolute value of a difference between the second center frequency and the third center frequency.

2. The antenna device according to claim 1, wherein the first radiator includes at least one first side to resonate in the first frequency range and at least one second side to resonate in the second frequency range, and the second radiator is closer to one of the at least one second side than to the at least one first side.

3. The antenna device according to claim 1, wherein
the first radiator includes a first end portion and a second end portion located on an opposite side from the first end portion, an electric field generated in the first end portion and an electric field generated in the second end portion have opposite polarities when the first radiator resonates in the first frequency range;
the second radiator is closer to the first end portion than to the second end portion; and
an electric field generated in the second radiator when the second radiator resonates in the third frequency range has a same polarity as an electric field generated in the first end portion of the first radiator.

4. The antenna device according to claim 2, wherein
the at least one second side of the first radiator is longer than the at least one first side of the first radiator; and
a first slit is on the at least one first side, a second slit is on the at least one second side, and the first slit is longer than the second slit.

5. The antenna device according to claim 1, wherein a first connection point at which the first radiator is connected to the first coil is located at a position spaced in one direction from a center axis of the first radiator.

6. The antenna device according to claim 1, wherein a second connection point at which the second radiator is connected to the second coil is at a position in the second radiator closer to the first radiator.

7. The antenna device according to claim 6, wherein the second radiator includes an open end located farthest from the second connection point and the open end is farther from the first radiator than the second connection point.

8. The antenna device according to claim 6, wherein the second radiator includes an open end located farthest from the second connection point and the open end is adjacent to or in a vicinity of the first radiator.

9. The antenna device according to claim 8, wherein the open end of the second radiator is adjacent to or in a vicinity of a portion of the first radiator where a generated electric field has a same polarity as an electric field generated at the open end of the second radiator.

10. An antenna device comprising:
a feeder circuit to process signals in a first frequency range, a second frequency range, and a third frequency range;
a first radiator with a patch structure capable of resonating in the first frequency range in a first direction and resonating in the second frequency range in a second direction;
a second radiator to resonate in the third frequency range;
a first coil connected between the feeder circuit and the first radiator; and
a second coil that is connected to the second radiator and that is magnetically coupled to the first coil; wherein
the first radiator includes a first end portion and a second end portion located on an opposite side from the first end portion, an electric field generated in the first end portion and an electric field generated in the second end portion have opposite polarities when the first radiator resonates in the first frequency range;
the second radiator is closer to the first end portion than to the second end portion; and
an electric field generated in the second radiator when the second radiator resonates in the third frequency range has a same polarity as an electric field generated in the first end portion of the first radiator.

11. The antenna device according to claim 10, wherein the first radiator includes at least one first side to resonate in the first frequency range and at least one second side to resonate in the second frequency range, and the second radiator is closer to one of the at least one second side than to the at least one first side.

12. The antenna device according to claim 10, wherein
the first radiator includes a first end portion and a second end portion located on an opposite side from the first end portion, an electric field generated in the first end portion and an electric field generated in the second end portion have opposite polarities when the first radiator resonates in the first frequency range;
the second radiator is closer to the first end portion than to the second end portion; and
an electric field generated in the second radiator when the second radiator resonates in the third frequency range has a same polarity as an electric field generated in the first end portion of the first radiator.

13. The antenna device according to claim 11, wherein
the at least one second side of the first radiator is longer than the at least one first side of the first radiator; and
a first slit is on the at least one first side, a second slit is on the at least one second side, and the first slit is longer than the second slit.

14. The antenna device according to claim 10, wherein a first connection point at which the first radiator is connected to the first coil is located at a position spaced in one direction from a center axis of the first radiator.

15. The antenna device according to claim 10, wherein a second connection point at which the second radiator is connected to the second coil is at a position in the second radiator closer to the first radiator.

16. The antenna device according to claim 15, wherein the second radiator includes an open end located farthest from the second connection point and the open end is farther from the first radiator than the second connection point.

17. The antenna device according to claim 15, wherein the second radiator includes an open end located farthest from the second connection point and the open end is adjacent to or in a vicinity of the first radiator.

18. The antenna device according to claim 17, wherein the open end of the second radiator is adjacent to or in a vicinity of a portion of the first radiator where a generated electric field has a same polarity as an electric field generated at the open end of the second radiator.
